(19) United States
(12) Patent Application Publication
(10) Pub. No.: US 2025/0201220 A1
(43) Pub. Date: Jun. 19, 2025

(54) MULTI-MEDIA SYSTEM AND METHOD FOR PERFORMING MULTI-MEDIA OPERATION IN MULTI-MEDIA SYSTEM

(71) Applicant: Realtek Semiconductor Corp., HsinChu (TW)

(72) Inventor: ZILIANG KUANG, Suzhou City (CN)

(73) Assignee: Realtek Semiconductor Corp., HsinChu (TW)

(21) Appl. No.: 18/976,280

(22) Filed: Dec. 10, 2024

(30) Foreign Application Priority Data
Dec. 18, 2023 (CN) 202311743429.5

(51) Int. Cl. G10H 1/00; G10H 1/36

(52) U.S. Cl. CPC G10H 1/0083; G10H 1/366; G10H 2210/005; G10H 2240/285; G10H 2240/321

(57) ABSTRACT

A multi-media system and a method for performing a multi-media operation in the multi-media system are provided. The multi-media system includes an audio input device and a multi-media electronic device, wherein the audio input device receives a human voice signal of a user and converts the human voice signal into human voice data, and the multi-media electronic device plays a processed human voice signal and an accompaniment signal corresponding to the human voice signal according to the human voice data. The multi-media electronic device includes a multi-media processor and an audio processor, wherein the multi-media processor selectively processes the human voice data according to a specific communication standard to generate processed audio data, and the audio processor plays the processed human voice signal and the accompaniment signal according to the processed audio data.

### BACKGROUND OF THE INVENTION

### 1. Field of the Invention

The present invention is related to multi-media applications, and more particularly, to a multi-media system (e.g. a Karaoke system) and a method for performing a multi-media operation (e.g. an entertainment activity such as Karaoke) in a multi-media system.

### 2. Description of the Prior Art

Various smart TV products (e.g. Android TV) are available on the market, wherein these smart TV products support many types of multi-media entertainment functions. Some entertainment activities such as Karaoke that use Bluetooth remote controllers are not supported on present Android TV platforms, however. Thus, there is a need for a novel architecture and an associated method, which can execute a Karaoke system on an Android TV, and more particularly, which can enable a Bluetooth remote controller (e.g. a Bluetooth microphone) to support operations of the Karaoke system such as control and voice receiving, thereby improving a user experience without introducing any side effect or in a way that is less likely to introduce side effects.

### SUMMARY OF THE INVENTION

An objective of the present invention is to provide a multi-media system (e.g. a Karaoke system) and a method for performing a multi-media operation (e.g. an entertainment activity such as Karaoke) in a multi-media system, which enable the multi-media operation to properly support various types of remote controller or microphones such as Bluetooth microphones and universal serial bus (USB) microphones.

At least one embodiment of the present invention provides a multi-media system. The multi-media system comprises an audio input device and a multi-media electronic device. The audio input device is configured to receive a human voice signal generated by a user and convert the human voice signal into human voice data. The multi-media electronic device is configured to receive the human voice data transmitted from the audio input device, and play a processed human voice signal and an accompaniment signal corresponding to the human voice signal according to the human voice data. The multi-media electronic device comprises a multi-media processor and an audio processor, where the audio processor is coupled to the multi-media processor. The multi-media processor is configured to determine whether the audio input device transmits the human voice data to the multi-media electronic device based on a specific communication standard, in order to selectively process the human voice data according to the specific communication standard to generate processed audio data. In addition, the audio processor is configured to play the processed human voice signal and the accompaniment signal according to the processed audio data.

At least one embodiment of the present invention provides a method for performing a multi-media operation in a multi-media system. The method comprises: utilizing an audio input device of the multi-media system to receive a human voice signal generated by a user and convert the human voice signal into human voice data; utilizing a multi-media electronic device of the multi-media system to receive the human voice data transmitted from the audio input device; utilizing a multi-media processor of the multi-media electronic device to determine whether the audio input device transmits the human voice data to the multi-media electronic device based on a specific communication standard, in order to selectively process the human voice data according to the specific communication standard to generate processed audio data; and utilizing an audio processor of the multi-media electronic device to play a processed human voice signal and an accompaniment signal corresponding to the human voice signal according to the processed audio data from the multi-media processor.

The multi-media system and the method provided by the embodiments of the present invention can perform associated processing on the human voice signal when the audio input device transmits the human voice signal according to the specific communication standard (e.g. Bluetooth communication standard), to thereby achieve the purpose of supporting Bluetooth microphones. In addition, the embodiments of the present invention will not greatly increase additional costs. Thus, the present invention can properly support various types of remote controllers or microphones without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-media system according to an embodiment of the present invention.

FIG. 2 is a diagram illustrating a control scheme of the multi-media system shown in FIG. 1 regarding an audio input device according to an embodiment of the present invention.

FIG. 3 is a diagram illustrating a working flow of a method for performing a multi-media operation in a multi-media system according to an embodiment of the present invention.

### DETAILED DESCRIPTION

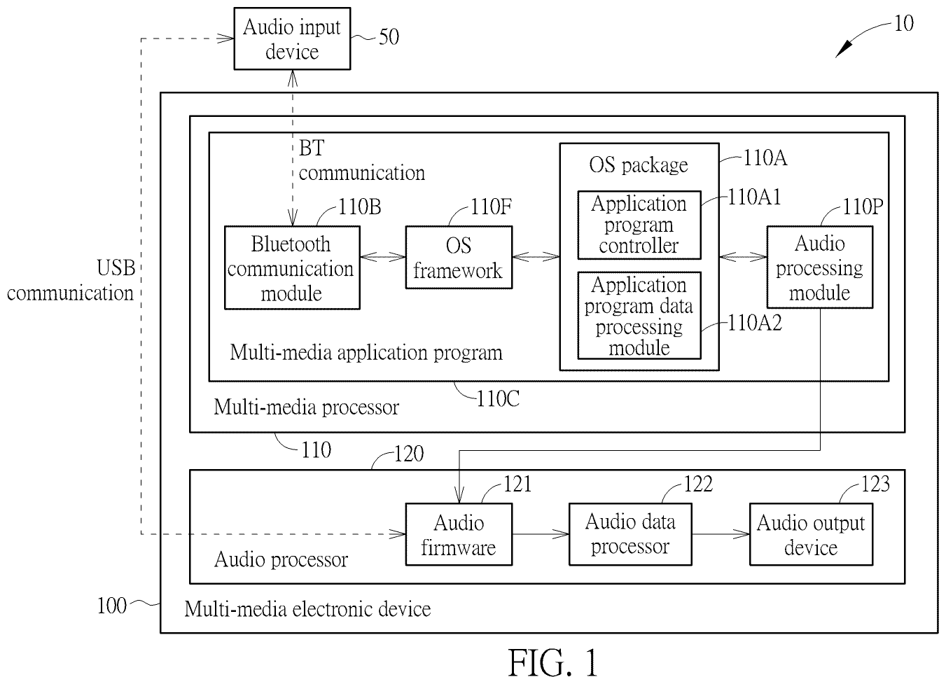

FIG. 1 is a diagram illustrating a multi-media system 10 according to an embodiment of the present invention. As shown in FIG. 1, the multi-media system 10 may comprise an audio input device 50 and a multi-media electronic device 100. Examples of the multi-media electronic device 100 may include, but are not limited to Android TVs equipped with Karaoke functions. Examples of the audio input device 50 may include, but not limited to Bluetooth microphones and universal serial bus (USB) microphones. When the audio input device 50 is a Bluetooth microphone, the audio input device 50 may communicate with the multi-media electronic device 100 via Bluetooth communication (labeled “BT communication” in FIG. 1 for brevity). When the audio input device 50 is a USB microphone, the audio input device 50 may communicate with the multi-media electronic device 100 via USB communication (e.g. via a USB cable). In this embodiment, the audio input device 50 is configured to receive a human voice signal generated by a user and convert the human voice signal into human voice data. In addition, the multi-media electronic device 100 is configured to receive the human voice data transmitted by the audio input device 50 (e.g. via the Bluetooth communication or the USB communication), and play a processed human voice signal and an accompaniment signal corresponding to the human voice signal according to the human voice data. In addition, the multi-media electronic device 100 may comprise a multi-media processor 110 and an audio processor 120, where the audio processor 120 is coupled to the multi-media processor 110. The multi-media processor 110 is configured to determine whether the audio input device 50 transmits the human voice data to the multi-media electronic device 110 based on a specific communication standard (e.g. the Bluetooth communication standard), in order to selectively process the human voice data according to the specific communication standard to generate processed audio data, and the audio processor 120 is configured to play the processed human voice signal and the accompaniment signal according to the processed audio data.

In this embodiment, when the multi-media processor 110 determines that the audio input device 50 transmits the human voice data to the multi-media electronic device 100 based on the specific communication standard such as the Bluetooth communication standard (e.g. transmitting the human voice data to the multi-media processor 110 via the Bluetooth communication shown in FIG. 1), the multi-media processor 110 may process the human voice data according to the specific communication standard (e.g. the Bluetooth communication standard) to generate the processed audio data, where the processed audio data may carry mixed audio data which is a mixture of the processed human voice signal and the accompaniment signal, to enable the audio processor 120 to play the processed human voice signal and the accompaniment signal according to the mixed audio data. When the multi-media processor 110 determines that the audio input device 50 transmits the human voice data to the multi-media electronic device 100 based on another communication standard (e.g. the USB communication standard) different from the specific communication standard, the audio processor 120 may receive the human voice data from the audio input device 50 according to the other communication standard such as the USB communication standard (e.g. receiving the human voice data from the audio input device 50 via the USB communication shown in FIG. 1), to enable the audio processor 120 to play the processed human voice signal according to the human voice data from the audio input device 50 and play the accompaniment signal according to the processed audio data from the multi-media processor 110.

In this embodiment, the multi-media processor 110 may execute a multi-media application program 110C (e.g. a Karaoke application program) to control operations of receiving the human voice data, processing the human voice data and generating the processed audio data based on the specific communication standard. In particular, the multi-media application program 110C may comprise a communication module such as a Bluetooth communication module 110B, an operating system (OS) frame work 110F (e.g. an Android framework), an OS package 110A such as an Android package (APK), and an audio processing module 110P. The Bluetooth communication module 110B is configured to receive the human voice data from the audio input device 50 according to the specific communication standard such as the Bluetooth communication standard, where the audio input device 50 (e.g. the Bluetooth microphone) may transmit Bluetooth packets of the human voice data with the aid of encoding techniques associated with the Bluetooth communication standard, and the Bluetooth communication module 110B may obtain the human voice data by decoding these Bluetooth packets with corresponding decoding techniques. The OS package 110A is configured to receive the human voice data from the Bluetooth communication module 110B via the OS framework 110F, and output raw audio data according to the human voice data. The audio processing module 110P is configured to perform pre-processing on the raw audio data to generate the processed audio data, where the pre-processing performed on the raw audio data by the audio processing module 110P may comprise volume adjustment or noise floor processing (e.g. performing corresponding volume adjustment operations or noise canceling operations in response to voice receiving conditions or settings of the audio input device 50).

In this embodiment, the OS package 110A may comprise a control module such as an application program controller 110A1, and a data processing module such as an application program data processing module 110A2, where the application program controller 110A1 is configured to control operations of the OS package 110A, and the application program data processing module 110A2 is configured to process the human voice data to output the raw audio data. More particularly, the application program data processing module 110A2 may determine intensity of the human voice data, to enable the application program controller 110A1 to control whether the audio input device 50 utilizes an audio encoding operation to transmit the human voice data according to the intensity. For example, the audio input device 50 may be preset to utilize pulse-code modulation (PCM) to transmit the human voice data. When the application program data processing module 110A2 determines that the intensity of the human voice data is insufficient (e.g. detecting a condition where packet(s) are missing in a process of receiving the human voice data), the application program controller 110A1 may issue an encoding request to the audio input device 50 via the OS frame 110F and the Bluetooth communication module 110B based on this determination result, in order to control the audio input device 50 to utilize adaptive differential pulse-code modulation (ADPCM) to transmit the human voice data, thereby reducing data bandwidth to prevent packets from getting lost, where the application program controller 110A1 may control the application program data processing module 110A2 to perform decoding associated with the ADPCM on the human voice data to generate the raw voice data. When the application program data processing module 110A2 determines that the intensity of the human voice data is sufficient (e.g. detecting a condition where no packet is missing in the process of receiving the human voice data), the application program controller 110A1 may maintain the present system setting (e.g. allowing the audio input device 50 to keep utilizing the PCM to transmit the human voice data) based on this determination result, in order to ensure that audio quality of the human voice data is optimized, where the application program data processing module 110A2 may generate the raw audio data without performing the decoding associated with the ADPCM on the human voice data.

In this embodiment, the audio processor 120 may comprise an audio firmware 121, an audio data processor such as an audio data processor 122, and an audio output device 123, where the audio firmware 121 is coupled to the multi-media processor 110, the audio data processor 122 is coupled to the audio firmware 121, and the audio output device 123 is coupled to the audio data processor 122. In particular, the multi-media processor 110 may write the processed audio data into the audio firmware 121 from the audio processing module 110P after the processed audio data is generated, to enable the audio data processor 122 to receive the processed audio data from the multi-media processor 110 via the audio firmware 121 and perform post-processing on the processed audio data to generate audio output data, where the audio output device 123 is configured to play the processed human voice signal and the accompaniment signal according to the audio output data. In some embodiments, the audio output device 123 may be a built-in speaker of the multi-media electronic device 100. In some embodiments, the audio output device 123 may be an audio output port, which enables an external speaker connected to the audio output port to play the processed human voice signal and the accompaniment signal.

In some embodiments, the post-processing performed on the processed audio data by the audio data processor 122 may comprise removing human voice portions within the accompaniment signal. For example, the audio data processor 122 may execute an artificial intelligence (AI) algorithm to remove human voice portions within a song, to make the sound played by the audio processor 120 only comprise the processed human voice signal derived by receiving a user voice and the accompaniment signal other than a human voice in the song. In addition, the post-processing performed on processed audio data by the audio data processor 122 may comprise acoustic echo cancellation (AEC), which can reduce echo interference as much as possible, thereby improving a user experience.

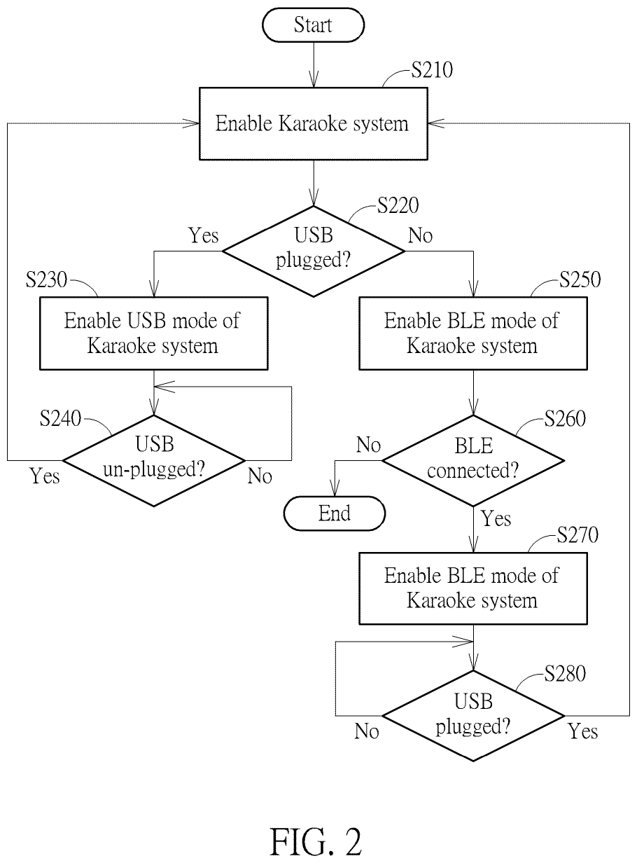

FIG. 2 is a diagram illustrating a control scheme of the multi-media system 10 shown in FIG. 1 regarding the audio input device 50 according to an embodiment of the present invention, where the working flow of the control scheme may be controlled by the application program controller 110A1 shown in FIG. 1, but the present invention is not limited thereto. It should be noted that the control scheme shown in FIG. 2 is for illustrative purposes only, and is not meant to be a limitation of the present invention. For example, one or more steps may be added, deleted or modified in the control scheme shown in FIG. 2. In addition, if an overall result is not affected, these steps do not have to be executed in the exact order shown in FIG. 2.

In Step S210, after the multi-media system 10 is powered on, the application program controller 110A1 may enable a Karaoke system.

In Step S220, the application program controller 110A1 may determine whether a USB microphone is plugged into the multi-media electronic device 100 (labeled “USB plugged?” in FIG. 2 for brevity). If the determination result shows “Yes”, the working flow proceeds with Step S230. If the determination result shows “No”, the working flow proceeds with Step S250.

In Step S230, the application program controller 110A1 may enable a USB mode of the Karaoke system to support operations of the USB microphone.

In Step S240, the application program controller 110A1 may determine whether the USB microphone is un-plugged (labeled “USB un-plugged?” in FIG. 2 for brevity). If the determination result shows “Yes”, the working flow proceeds with Step S210. If the determination result shows “No”, the working flow proceeds with Step S240.

In Step S250, the application program controller 110A1 may enable a Bluetooth low energy (BLE) mode of the Karaoke system to support detection of Bluetooth microphones (e.g. detecting existence of any Bluetooth microphone).

In Step S260, the application program controller 110A1 may determine whether any Bluetooth microphone is connected to the multi-media electronic device 100 (labeled “BLE connected?” in FIG. 2 for brevity). If the determination result shows “Yes”, the working flow proceeds with Step S270. If the determination result shows “No”, the working flow ends.

In Step S270, the application program controller 110A1 may enable the BLE mode of the Karaoke system to support operations of the Bluetooth microphone.

In Step S280, the application program controller 110A1 may determine whether a USB microphone is plugged into the multi-media electronic device 100 (labeled “USB plugged?” in FIG. 2 for brevity). If the determination result shows “Yes”, the working flow proceeds with Step S210. If the determination result shows “No”, the working flow proceeds with Step S280.

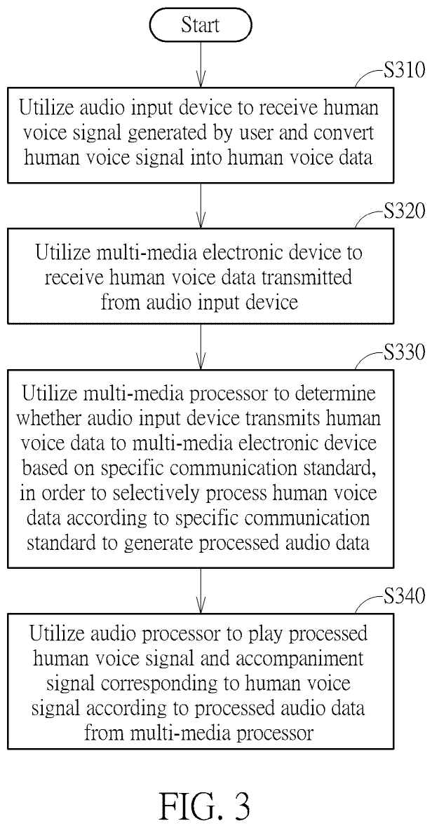

FIG. 3 is a diagram illustrating a working flow of a method for performing a multi-media operation (e.g. a Karaoke function) in the multi-media system 10 according to an embodiment of the present invention. It should be noted that the working flow shown in FIG. 3 is for illustrative purposes only, and is not meant to be a limitation of the present invention. For example, one or more steps may be added, deleted or modified in the working flow shown in FIG. 3. In addition, if an overall result is not affected, these steps do not have to be executed in the exact order shown in FIG. 3.

In Step S310, the multi-media system 10 may utilize the audio input device 50 thereinto receive a human voice signal generated by a user and convert the human voice signal into human voice data.

In Step S320, the multi-media system 10 may utilize the multi-media electronic device 100 therein to receive the human voice data transmitted from the audio input device 50.

In Step S330, the multi-media system 10 may utilize the multi-media processor 110 within the multi-media electronic device 100 to determine whether the audio input device 50 transmits the human voice data to the multi-media electronic device 100 based on a specific communication standard (e.g. the Bluetooth communication standard), in order to selectively process the human voice data according to the specific communication standard to generate processed audio data.

In Step S340, the multi-media system 10 may utilize the audio processor 120 within the multi-media electronic device 100 to play a processed human voice signal and an accompaniment signal corresponding to the human voice signal according to the processed audio data from the multi-media processor 110.

To summarize, the multi-media system 10 and the associated method of the present invention can configure a corresponding communication module and signal processing module in a multi-media processor, in order to support remote controllers or microphones which communicate with the multi-media electronic device 100 by utilizing a specific communication standard (e.g. the Bluetooth communication standard). In addition, the embodiments of the present invention will not greatly increase additional costs. Thus, the present invention can properly support various types of remote controllers or microphones without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-media system, comprising:
an audio input device, configured to receive a human voice signal generated by a user and convert the human voice signal into human voice data; and
a multi-media electronic device, configured to receive the human voice data transmitted from the audio input device, and play a processed human voice signal and an accompaniment signal corresponding to the human voice signal according to the human voice data, wherein the multi-media electronic device comprises:
a multi-media processor, configured to determine whether the audio input device transmits the human voice data to the multi-media electronic device based on a specific communication standard, in order to selectively process the human voice data according to the specific communication standard to generate processed audio data; and
an audio processor, coupled to the multi-media processor, configured to play the processed human voice signal and the accompaniment signal according to the processed audio data.

2. The multi-media system of claim 1, wherein when the multi-media processor determines that the audio input device transmits the human voice data to the multi-media electronic device based on the specific communication standard, the multi-media processor processes the human voice data according to the specific communication standard to generate the processed audio data, and the processed audio data carries mixed audio data being a mixture of the processed human voice signal and the accompaniment signal, to enable the audio processor to play the processed human voice signal and the accompaniment signal.

3. The multi-media system of claim 1, wherein when the multi-media processor determines that the audio input device transmits the human voice data to the multi-media electronic device based on another communication standard different from the specific communication standard, the audio processor receives the human voice data from the audio input device according to the other communication standard, to enable the audio processor to play the processed human voice signal according to the human voice data and play the accompaniment signal according to the processed audio data.

4. The multi-media system of claim 1, wherein the multi-media processor executes a multi-media application program, to control operations of receiving the human voice data, processing the human voice data and generating the processed audio data based on the specific communication standard, and the multi-media application program comprises:
a communication module, configured to receive the human voice data from the audio input device according to the specific communication standard;
an operating system (OS) package, configured to receive the human voice data from the communication module via an OS framework, and output raw audio data according to the human voice data; and
an audio processing module, configured to perform pre-processing on the raw audio data to generate the processed audio data.

5. The multi-media system of claim 4, wherein the OS package comprises:
a control module, configured to control operations of the OS package; and
a data processing module, configured to process the human voice data to output the raw audio data;
wherein the data processing module determines intensity of the human voice data, to enable the control module to control whether the audio input device utilizes an audio encoding operation to transmit the human voice data according to the intensity.

6. The multi-media system of claim 4, wherein the pre-processing performed on the raw audio data by the audio processing module comprises volume adjustment or noise floor processing.

7. The multi-media system of claim 1, wherein the audio processor comprises:
an audio data processor, configured to receive the processed audio data from the multi-media processor via an audio firmware, and perform post-processing on the processed audio data to generate audio output data; and
an audio output device, configured to play the processed human voice signal and the accompaniment signal according to the audio output data.

8. The multi-media system of claim 7, wherein the post-processing performed on the processed audio data by the audio data processor comprises removing human voice portions within the accompaniment signal.

9. The multi-media system of claim 7, wherein the post-processing performed on the processed audio data by the audio data processor comprises acoustic echo cancellation (AEC).

10. A method for performing a multi-media operation in a multi-media system, comprising:
utilizing an audio input device of the multi-media system to receive a human voice signal generated by a user and convert the human voice signal into human voice data;
utilizing a multi-media electronic device of the multi-media system to receive the human voice data transmitted from the audio input device;
utilizing a multi-media processor of the multi-media electronic device to determine whether the audio input device transmits the human voice data to the multi-media electronic device based on a specific communication standard, in order to selectively process the human voice data according to the specific communication standard to generate processed audio data; and
utilizing an audio processor of the multi-media electronic device to play a processed human voice signal and an accompaniment signal corresponding to the human voice signal according to the processed audio data from the multi-media processor.

11. The method of claim 10, wherein utilizing the multi-media processor of the multi-media electronic device to determine whether the audio input device transmits the human voice data to the multi-media electronic device based on the specific communication standard in order to selectively process the human voice data according to the specific communication standard to generate the processed audio data comprises:
in response to the multi-media processor determining that the audio input device transmits the human voice data to the multi-media electronic device based on the specific communication standard, utilizing the multi-media processor to process the human voice data according to the specific communication standard to generate the processed audio data;
wherein the processed audio data carries mixed audio data being a mixture of the processed human voice signal and the accompaniment signal, to enable the audio processor to play the processed human voice signal and the accompaniment signal.

12. The method of claim 10, wherein utilizing the multi-media processor of the multi-media electronic device to determine whether the audio input device transmits the human voice data to the multi-media electronic device based on the specific communication standard in order to selectively process the human voice data according to the specific communication standard to generate the processed audio data comprises:
in response to the multi-media processor determining that the audio input device transmits the human voice data to the multi-media electronic device based on another communication standard different from the specific communication standard, utilizing the audio processor to receive the human voice data from the audio input device according to the other communication standard, to enable the audio processor to play the processed human voice signal according to the human voice data and play the accompaniment signal according to the processed audio data.

13. The method of claim 10, further comprising:
utilizing the multi-media processor to execute a multi-media application program, to control operations of receiving the human voice data, processing the human voice data and generating the processed audio data based on the specific communication standard, wherein operations of the multi-media application program comprise:
utilizing a communication module of the multi-media application program to receive the human voice data from the audio input device according to the specific communication standard;
utilizing an operating system (OS) package of the multi-media application program to receive the human voice data from the communication module via an OS framework, and output raw audio data according to the human voice data; and
utilizing an audio processing module of the multi-media application program to perform pre-processing on the raw audio data to generate the processed audio data.

14. The method of claim 13, wherein utilizing the OS package of the multi-media application program to receive the human voice data from the communication module via the OS framework and output raw audio data according to the human voice data comprises:
utilizing a control module of the OS package to control operations of the OS package; and
utilizing a data processing module of the OS package to process the human voice data to output the raw audio data;
wherein the data processing module determines intensity of the human voice data, to enable the control module to control whether the audio input device utilizes an audio encoding operation to transmit the human voice data according to the intensity.

15. The method of claim 13, wherein the pre-processing performed on the raw audio data by the audio processing module comprise volume adjustment or noise floor processing.

16. The method of claim 10, wherein utilizing the audio processor of the multi-media electronic device to play the processed human voice signal and the accompaniment signal corresponding to the human voice signal according to the processed audio data from the multi-media processor comprises:
utilizing an audio data processor of the audio processor to receive the processed audio data from the multi-media processor via an audio firmware, and perform post-processing on the processed audio data to generate audio output data; and
utilizing an audio output device of the audio processor to play the processed human voice signal and the accompaniment signal according to the audio output data.

17. The method of claim 16, wherein the post-processing performed on the processed audio data by the audio data processor comprises removing human voice portions within the accompaniment signal.

18. The method of claim 16, wherein the post-processing performed on the processed audio data by the audio data processor comprises acoustic echo cancellation (AEC).
